(19) United States
(12) Patent Application Publication
(10) Pub. No.: US 2012/0026552 A1
(43) Pub. Date: Feb. 2, 2012

(54) IMAGE PROCESSING APPARATUS AND METHOD FOR CONTROLLING THE SAME

(75) Inventor: Toshiaki Shirai, Tokyo (JP)

(73) Assignee: CANON KABUSHIKI KAISHA, Tokyo (JP)

(21) Appl. No.: 13/187,043

(22) Filed: Jul. 20, 2011

(30) Foreign Application Priority Data
Jul. 28, 2010 (JP) 2010-169603

(51) Int. Cl. G06K 15/02

(52) U.S. Cl. 358/1.18

(57) ABSTRACT

A control method for controlling an image processing apparatus for printing a first image file including a plurality of image frames on a paper sheet, the control method includes a first obtaining step of obtaining a total number of the image frames included in the first image file, a second obtaining step of obtaining a number of image frames to be printed on one paper sheet, a third obtaining step of obtaining a number of paper sheets to be used for printing, and a selecting step of automatically selecting the image frames to be printed based on the total number of the image frames obtained by the first obtaining step, the number of the image frames to be printed on one paper sheet obtained by the second obtaining step, and the number of paper sheets to be used for printing obtained by the third obtaining step.

### BACKGROUND OF THE INVENTION

1. Field of the Invention

The present invention relates to an image processing apparatus and a method for controlling the image processing apparatus.

2. Description of the Related Art

Heretofore, there has been known an index print in which images captured by a camera are listed at the time of printing the images captured by the camera as discussed in Japanese Patent Application Laid-Open No. 2005-25125.

As a method for performing the index print, a method has been known in which a specific image is printed in a large size and, in a series of images, only a representative image is printed to perform the index print high in utility value as discussed in Japanese Patent Application Laid-Open No. 2006-330195, for example.

The printing method of a conventional index print has its purpose to facilitate printing the images captured by a camera. In particular, displaying a list of the images captured by a camera allows selecting an image desired to be printed while viewing the list, enabling easily identifying the image desired to be printed.

In recent years, there has been known an image file format capable of having a plurality of image frames as one file.

The file format can handle a plurality of images (for example, a series of images continuously captured with a digital camera) with relevance as one file. The conventional index print cannot handle an image with such a file format.

### SUMMARY OF THE INVENTION

According to an aspect of the present invention, an image processing apparatus capable of printing a first image file including a plurality of image frames on a paper includes a first obtaining unit configured to obtain the total number of the image frames included in the first image file, a second obtaining unit configured to obtain the number of the image frame to be printed on one paper, a third obtaining unit configured to obtain the number of papers used for printing, and a selecting unit configured to automatically select the image frame to be printed based on the total number of the image frames obtained by the first obtaining unit, the number of the image frames to be printed on one paper obtained by the second obtaining unit, and the number of papers used for printing obtained by the third obtaining unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a control configuration of an image processing apparatus.

FIG. 2 illustrates an example format configuration for recording a plurality of still images as one file.

FIG. 3 illustrates an example configuration of a file header in FIG. 2.

FIG. 4 illustrates an example configuration of the page header in an image file including a plurality of image data handled in the image processing apparatus.

FIG. 5 illustrates print setting performed when the image processing apparatus outputs the image file whose configuration example is illustrated in FIGS. 2 and 3.

FIG. 6 illustrates an example UI display in a case where the print setting described in FIG. 5 is performed by using the operation unit.

FIG. 7 illustrates an example processing performed by the image processing apparatus in printing the image file.

FIG. 8 illustrates an example layout printing in a case where all the frames of the image file have been printed according to the designated print layout.

FIG. 9 illustrates an example of printing in a case where a frame to be printed is selected by “equal thinning”.

FIG. 10 illustrates an example printing in a case where a frame to be printed is selected by “sequence printing”.

FIG. 11 illustrates an example printing in a case where a frame to be printed is selected by “central reference-point printing”.

FIG. 12 illustrates an example print setting in a case where the image processing apparatus outputs the image file whose configuration example is illustrated in FIGS. 2 and 3.

FIG. 13 illustrates an example UI display in a case where the print setting described in FIG. 11 is performed by using the operation unit.

FIG. 14 illustrates an example processing performed by the image processing apparatus in printing the image file.

### DESCRIPTION OF THE EMBODIMENTS

Various exemplary embodiments, features, and aspects of the invention will be described in detail below with reference to the drawings.

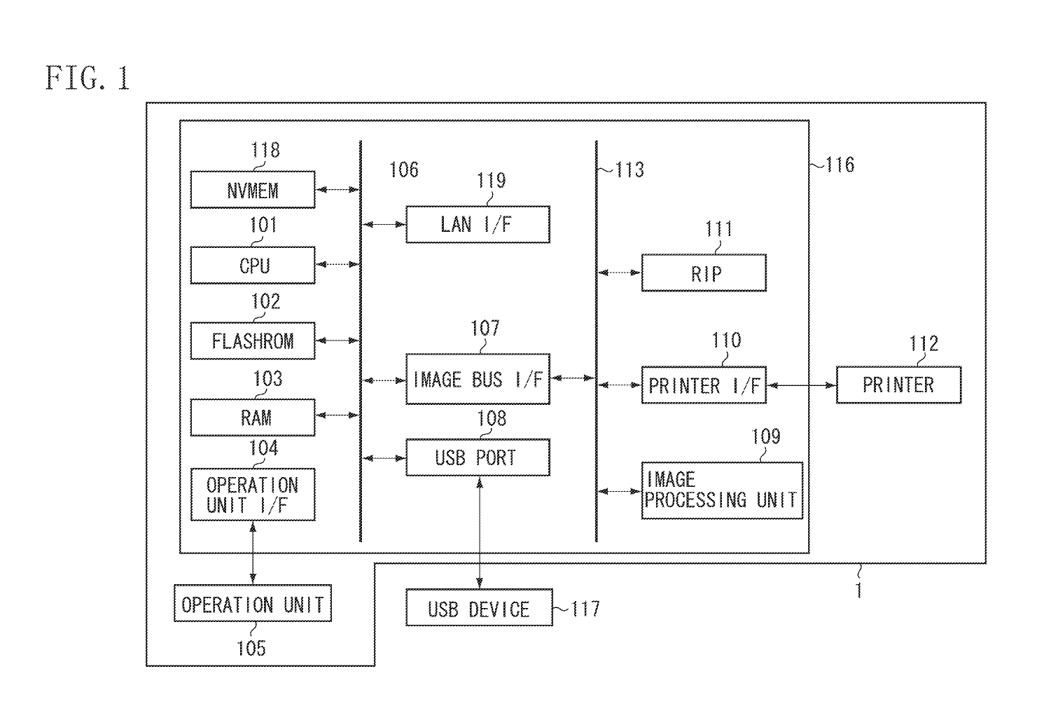

FIG. 1 illustrates a hardware configuration of an image processing apparatus 1 according to an exemplary embodiment of the present invention.

The image processing apparatus 1 includes a controller unit 116, an operation unit 105 for operating the image processing apparatus 1, and a printer 112 for printing the image processed by the image processing apparatus 1.

There is described herein an example where the image processing apparatus 1 is connected only with the printer 112, however, it is not limited to this. The image processing apparatus 1 may be a multifunction peripheral with a scanner for reading images and a hard disk for storing images.

Next, the controller unit 116 is described below. A CPU 101 is a processor for controlling the entire system. An NVMEM 118 stores programs for operating the CPU 101, various setting values for the image processing apparatus 1, and image data. The NVMEM 118 is a nonvolatile memory.

A flash ROM 102 is a rewritable nonvolatile memory and stores various control programs for controlling the system. A RAM 103 is a memory for temporarily storing image data and is used as a work memory for executing programs and performing image processing.

An operation-unit I/F 104 is an interface unit with the operation unit 105 and outputs information to be displayed on the operation unit 105 to the operation unit 105. The operation-unit I/F 104 also has a function to transfer information input by a user via the operation unit 105 to the CPU 101. A USB port 108 enables connection with an external USB device 117. The above devices are arranged on the system bus 106.

An image bus I/F 107 is an interface for connecting an image bus 113 for transferring image data at a high speed to a system bus 106. The image bus 113 includes a PCI bus or an IEEE 1394 bus.

The following devices are arranged on the image bus 113. A raster image processor (RIP) 111 rasterizes vector data such as PDL code into a bit map image. A printer I/F 110 connects a printer 112 to a controller unit 116.

An image processing unit 109 performs processing on the input image data, such as correction, treatment, and editing, and performs processing on the print-output image data, such as correction of a printer and resolution conversion. In addition to the above, the image processing unit 109 rotates image data and performs JPEG compression/expansion processing on multivalued image data, and JBIG, MMR, and MH compression/expansion processing on binary image data.

The printer 112 is a unit for converting raster image data into an image on a sheet. A printing method includes an electrophotographic method which uses a photosensitive drum and a photosensitive belt, and an inkjet method in which ink is discharged from a minute nozzle array to directly print image on a sheet, and any printing method may be used.

The image processing apparatus 1 includes a printer 112, but not limited to this. The printer 112 may be an external device of the image processing apparatus 1. Alternatively, the image processing apparatus 1 may include a scanner unit for reading a document instead of the printer. Printing is started by a print start instruction from the CPU 101.

The operation unit 105 includes an LCD display unit and operation keys. The LCD display unit is a touch-panel display unit. The LCD display unit displays buttons corresponding to the operation keys.

The LCD display unit displays the operation screen of the system and notifies the CPU 101 of the positional information of the button when the displayed specific button is touched. The CPU 101 executes the operation corresponding to the touched button according to the program stored in the NVMEM 118.

ALAN interface 119 is a unit for connecting the image processing apparatus 1 to a network such as a LAN and the Internet. The LAN interface 119 is used to transmit image data to and receive from an external apparatus, acquire the status of other devices via the LAN, and send back status.

The image processing apparatus 1 is connected to other image processing apparatus (not illustrated), a personal computer (not illustrated), and a server (not illustrated) via the LAN interface 119.

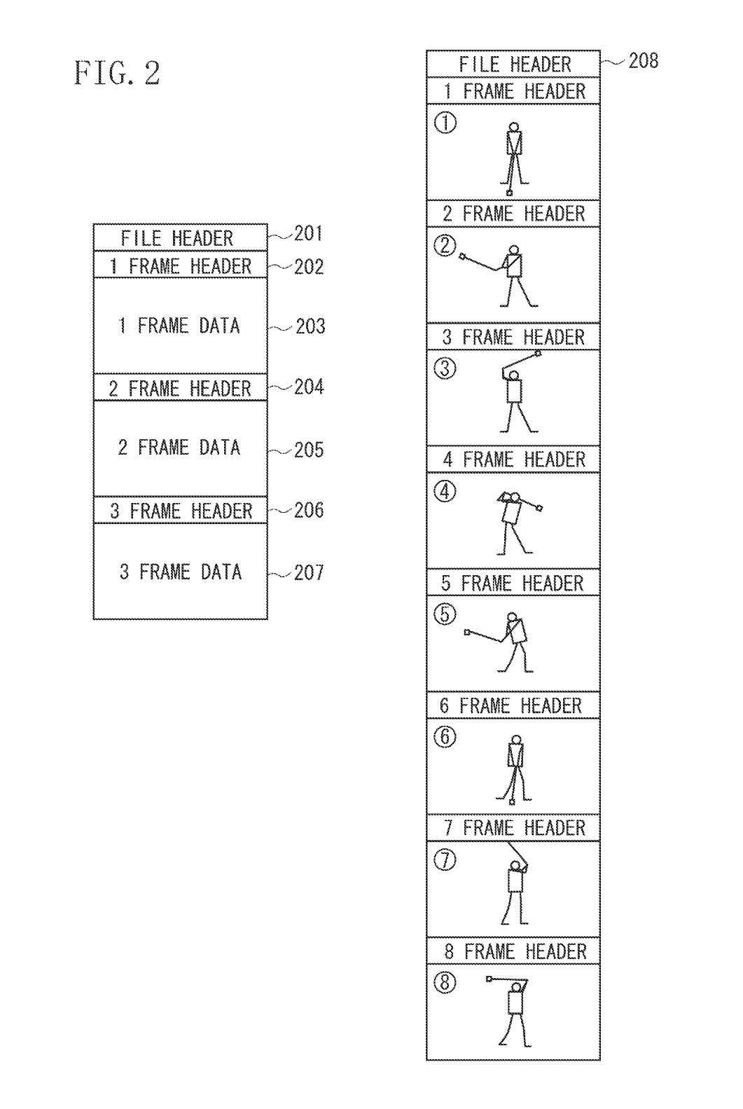

FIG. 2 illustrates an example format configuration for recording a plurality of still images, as one file, handled by the image processing apparatus 1 according to the present exemplary embodiment.

The format for recording the plurality of still images includes items such as a file header 201, page headers 202, 204, and 206, and page data 203, 205, and 207. The file header 201 describes information about the entire file. The page headers (also referred to as frame header) 202, 204, and 206 record information on each page (or, also referred to as each frame) included in the file. The page data (or frame data) 203, 205, and 207 include items for recording image data of each page (or, also referred to as each frame).

In the file header 201, the size of a target file and information indicating that the file is a multi-image file being a format capable of storing a plurality of still images as one file, are recorded. Also, in the file header 201, the address of the page header 202 on the first page, the address of the page header 204 on the second page, and the address of the page header 206 on the third page, are recorded.

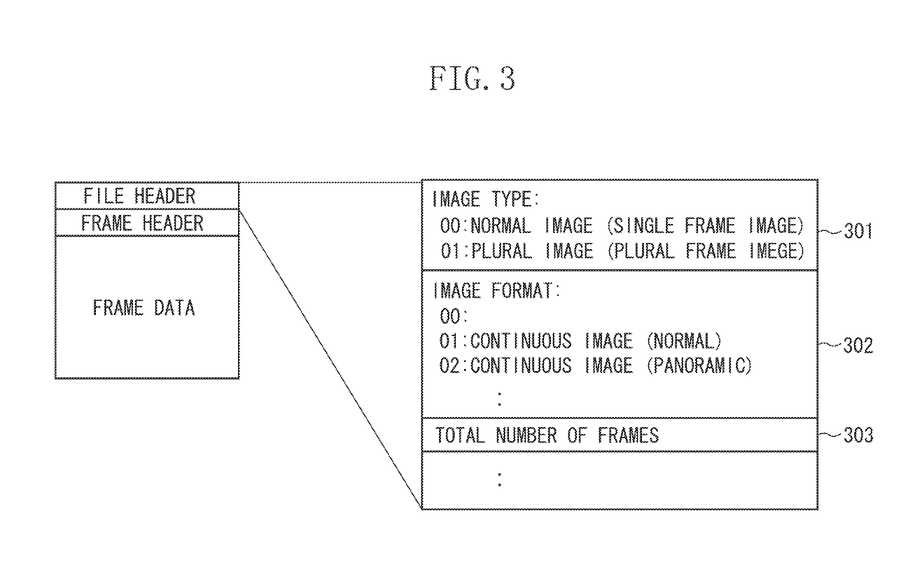

The format for recording the plurality of still images as one file includes a plurality of pairs of the page header and the page data. As exemplified in FIG. 2, the 1 page header 202 is header information describing information about the 1 page data 203. The relations between the 2 page header 204 and the 2 page data 205, and between the 3 page header 206 and the 3 page data 207 are similar to the above. Each page data describes still image data. The details of each page header are described below with reference to FIG. 3.

Although the case where three pairs of the page header and the page data exist is described above, the number of pairs of the page header and the page data is not limited to three pairs, and may be n (natural number) pairs.

In the present exemplary embodiment, the example where information about each page data is recorded in the page header corresponding to the page data is described, but not limited to this, information about each page data is collectively recorded. In that case, the information about each page data can be acquired from the file header 201.

A device (an image processing apparatus) which does not adapt to the format recognizes only a file of an image file format in which an image file has only one image frame. For this reason, in a case where the file of the image format illustrated in FIG. 2 is referred to, only the 1 page header 202 and the 1 page data 203 can be referred to.

An actual example is cited below in which a plurality of still images is handled as one file. An example 208 illustrates that a plurality of continuously captured images is handled as one file.

The details of the file header are described below with reference to FIG. 3. FIG. 3 illustrates an example configuration of the file header 201 in FIG. 2.

An image type 301 in the file header 201 indicates a file format. “00” in the image type 301 in the file header 201 represents a conventional image file of single page data, in other words, a generally used image file such as JPG or TIFF with a single image file.

“01” in the image type 301 in the file header 201 represents a file including a plurality of still images (a plurality of page data images). If there is no information about the image type 301 in the analyzed file header 201, the file is determined as a conventional image file of a single frame.

An image type 302 in the file header 201 indicates a format of an image stored in the image file. “00” in the image type 302 in the file header 201 represents a discontinuous image. “01” in the image type 302 in the file header 201 represents continuously captured images.

The continuously captured image refers to an image continuously captured by a camera or multiple viewpoint image (multi-view image) continuously captured by a plurality of cameras. “02” in the image type 302 represents a continuous image captured as a panoramic image.

The number of page data (the number of image frames) included in the one image file is recorded as the total number of frames 303.

In the file header 201, various data required as information about the image file are stored, in addition to the above information. The description thereof is omitted herein.

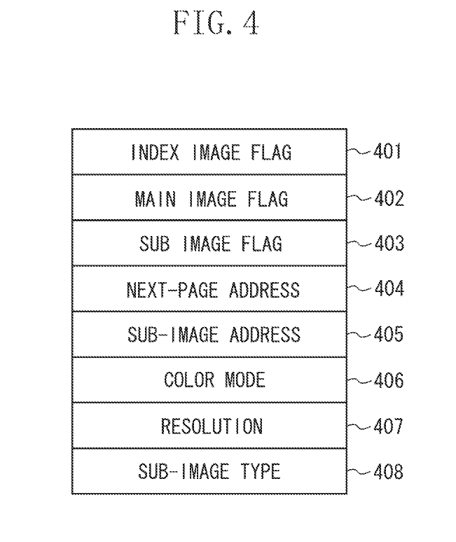

The page header in the image file format is described below with reference to FIG. 4.

FIG. 4 illustrates an example of configuration of the page header in a multi-image file including a plurality of image data handled in the image processing apparatus according to the present exemplary embodiment.

As illustrated in FIG. 4, an index image flag 401 in the page header is an area indicating whether the page data (image data) corresponding to the page header is an index image or not. The index image refers to a representative image among a plurality of images included in the file.

Only one index image always exists in each file in the format. An image positioned at the head (a position which is the nearest to the file header) of a file is set by default as the index image at the time of creating a file. The index image can be changed by the user after the file is created.

A main image flag 402 is an area indicating whether the page data corresponding to the page header is a main image (parent image) or not. When “1” is set to the main image flag 402, the page data is the main image. If the page data is the main image, the page data can include a sub image (child image) belonging to the main image.

A sub image flag 403 is an area indicating whether the page data corresponding to the page header is a sub image or not. When “1” is set to the sub image flag 403, the page data is a sub image.

A next-page address 404 stores a page-header address on the page next to the page. In the case of the final page, “0” is stored as a value indicating the final page.

A sub-image address 405 is an item provided only in the case where the page is the main image, and the address of page header of the sub image belonging to the page is stored therein.

If there exists a plurality of sub images, the addresses of the plurality of sub images are stored. For a parent image without a sub image (a child image), the main image flag 402 is turned on and then “0” is stored as a value representing that the sub image does not exist in the sub-image address 405.

A color mode 406 indicates whether the page is a color image or a monochrome image.

A resolution 407 shows the resolution of the page. If the image of the page is a sub image (a child image), a sub-image type (subordinate image type) 408 indicates a relationship between the sub image and a main image (a parent image).

For example, in a case where the sub image is a preview image in which the size of the main image is reduced, the value indicating that the image of the page is the preview image is stored.

In addition to the above sub image, the multiple viewpoint image (the multi-view image) may also be included therein, which is generated by capturing the same object from different viewpoints with digital cameras. In that case, the value indicating that the image of the page is the image for the multiple viewpoint image is stored.

In addition to the above sub images, the continuous captured image, which is continuously captured using the continuous image-capturing function of a digital camera, may also be included in the sub image. In that case, the value indicating that the image of the page is the continuously captured images, is stored. Also, in that case, information indicating the order in which the image is shot among a plurality of the continuously captured images may be stored.

A bracket image captured with conditions such as the exposure of a digital camera being changed may also be included in the sub image. In that case, information indicating that the image of the page is the bracket image (an input condition change image) is stored.

A panoramic image generated by capturing a panoramic image in which one image is formed of a plurality of images using the panoramic image-capturing function of a digital camera may also be included in the sub image. In that case, information indicating that the image of the page is the panoramic image is stored. The sub image may be other types of images.

A sub-image type 408 stores information for causing the image processing apparatus to recognize that the image of the page is a preview image, a multi-view image, a continuous shooting image, a bracket image, or a panoramic image.

This is one example of a file format. It is to be understood that the file format is not limited to this configuration.

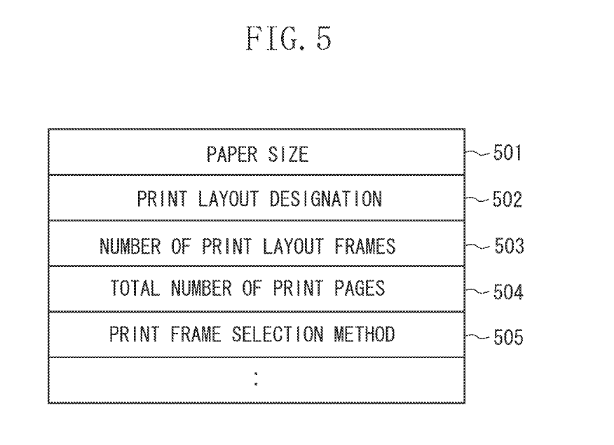

FIG. 5 illustrates an example print setting performed when the controller unit 116 outputs the image file whose configuration example is illustrated in FIGS. 2 to 4. Such print setting is controlled by the CPU 101 according to the programs stored in the NVMEM 118 or the flash ROM 102.

The print setting may be performed by the user using the operation unit I/F 104 or performed by other devices using the LAN I/F 119. The print setting is stored in the NVMEM 118.

A paper size 501 is the one for designating the size of paper used in printing an image file. A print layout designation 502 is the one for designating whether a plurality of pages (frames) is arranged side by side and printed on one paper used in printing.

The number of print layout pages (frames) 503 is the one for setting the number of print layout pages (the number of frames) of an image to be printed on one page among page data (frame data) included in the image file in a case where the print layout designation 502 is effective.

The total number of print pages 504 is the one for setting the number of papers used for printing one file in a case where the print layout designation 502 is effective.

A print frame selection method 505 is the one for selecting a printing page (an image frame) from images of a plurality of pages (a plurality of frames) included in the image file in a case where the print layout designation 502 is designated.

In addition to the above print setting, information required for printing the image file, such as information about color/monochrome designation and resolution designation, is included. The description thereof is omitted herein.

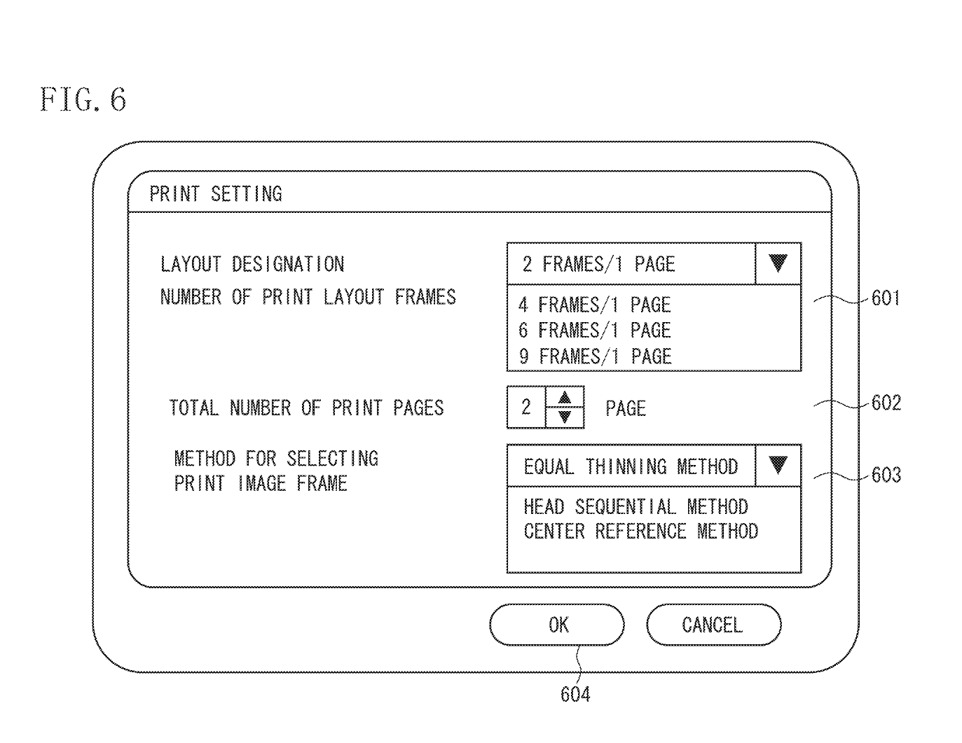

FIG. 6 illustrates an example user interface (UI) display designated by using the operation unit 105 in a case where the print setting described in FIG. 5 is performed. The following description is made on the consumption that the setting illustrated in FIGS. 5 and 6 has been already completed. Such a screen display is controlled by the CPU 101 according to the programs stored in the NVMEM 118 or the flash ROM 102.

The operation unit 105 instructed by the user to display a print setting screen transmits the instruction to the CPU 101 via the operation unit I/F 104. The CPU 101 receiving the instruction reads the print setting screen stored in the NVMEM 118 and causes the operation unit 105 to display the print setting screen based on the contents thereof.

An example print setting UI screen displayed on the operation unit 105 is described below. A layout designation (the number of print layout designation frames) 601 is the one for designating the number of printing page data (the number of frames) on one paper (or one face) on which printing is actually performed. More specifically, the user can designate the number of frames such as “2 frames/paper”, “4 frames/paper”, and “6 frames/paper”.

The total number of print pages 602 is capable of setting the number of papers used for printing in a case where the print layout designation 502 is effective.

A print image frame selection method 603 is capable of designating a method for extracting page data (image frame) to be printed from each page data (each image frame) included in the image file in a case where the print layout designation 502 is effective.

The operation unit 105 receiving the selection of the OK button 604 from the user is held in the print layout designation 502 in the NVMEM 118 via the operation unit I/F 104 and referred to when the controller unit 116 generates printing data.

In the above, description is made so that setting is performed on the operation unit 105, but it is not limited to this. It is needless to say that instructions may be received from other devices via the LAN I/F 119.

The print image frame selection method 505 in FIG. 6 describes an example set before printing is executed. In addition to the above, the operation unit 105 may display a screen for selecting the print image frame by using the operation unit 105 after printing is performed by the controller unit 116. The UI screen illustrated in FIG. 6 is an example, but not limited to this.

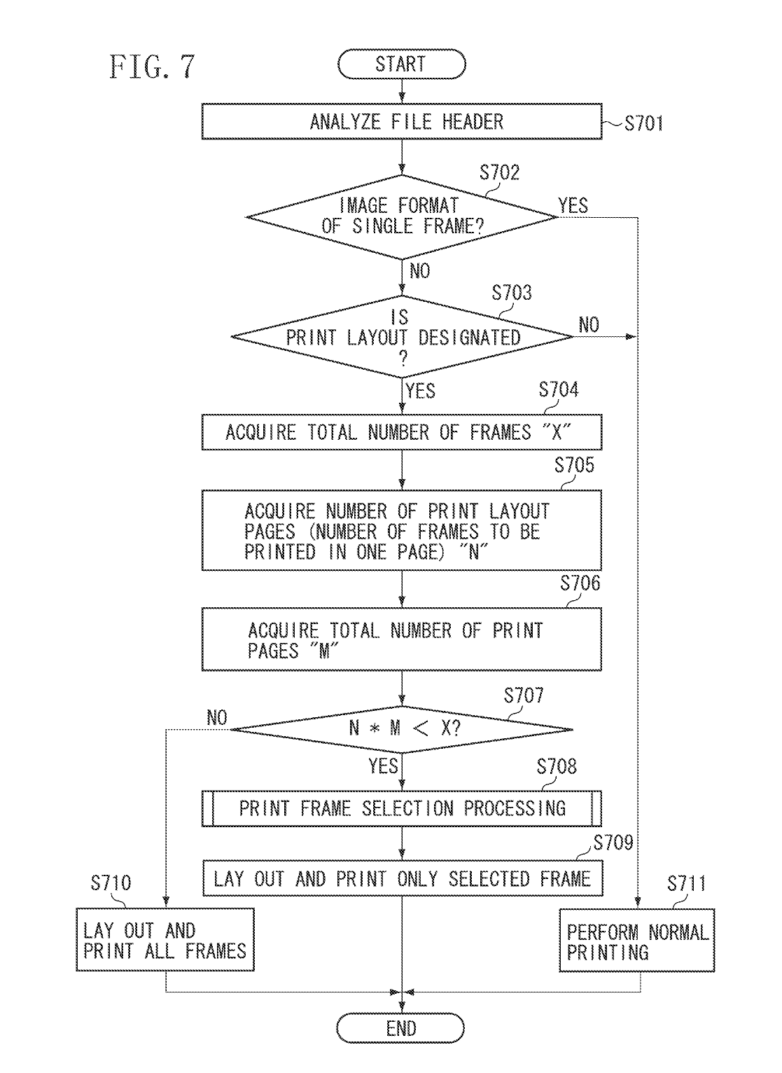

A specific method for using the setting items is described referring to FIG. 7.

FIG. 7 is a flow chart illustrating the processing of the image processing apparatus in a case where the image file is printed. The flow chart in FIG. 7 is executed by the CPU 101 according to the program stored in the NVMEM 118 or the flash ROM 102.

In step S701, when the user performs a file output operation by using the operation unit I/F 104, the CPU 101 analyzes the image file header 201. In step S702, the CPU 101 determines whether the file format is a normal image file format consisting of a single image formed of one image frame or an image file format consisting of a plurality of images based on the contents of the image type 301 in the file header 201.

If the CPU 101 determines that the file format is the image file format comprised of a single image (a single frame image) (YES in step S702), in step S711, normal printing in which one image is printed on paper is performed.

If the CPU 101 determines that the file format is the image file format consisting of a plurality of images (NO in step S702), in step S703, the CPU 101 determines whether the print layout designation 502 among print settings stored in the NVMEM 118 is performed.

If the CPU 101 determines that the print layout designation 502 is not performed (NO in step S703), in step S711, normal printing in which one image frame is printed one paper is performed.

If the CPU 101 determines that the print layout designation 502 is performed (YES in step S703), in step S704, the CPU 101 acquires the total number of frames 303 from the image file header 201 and temporarily stores the acquired total number of frames “X” in the RAM 103.

In step S705, the CPU 101 refers to the NVMEM 118, acquires the number of print layout frames 503 indicating the number of frames to be printed on one page at the time of print layout, and temporarily stores the acquired number of print layout frames “N” in the RAM 103.

In step S706, the CPU 101 refers to the NVMEM 118, acquires the total number of print pages 504 indicating the number of paper sheets used for printing, and temporarily stores the acquired the total number of print pages “M” in the RAM 103.

The CPU 101 reads the total number of frames “X”, the number of print layout frames “N”, and the total number of print pages “M” stored in the RAM 103 in steps S704, S705, and S706.

The CPU 101 determines whether all the plurality of frames of the image file can be printed with the designated print layout and on the designated number of paper sheets based on the referred numeric value.

More specifically, in step S707, the product of the number of print layout frames “N” and the total number of print pages “M” is equal to the printable number of frames, so that the product is compared with the total number of image frames “X” stored in the image file.

If N×M≧X (NO in step S707), the total number of frames “X” in the image file is equal to or smaller than the printable number of frames “N×M”, so that all the image frames in the image file can be printed. All the frames are laid out on the paper according to the designation of the print layout, and printed.

If N×M<X (Yes in step S707), the printable number of frames “N×M” is smaller than the total number of frames “X” in the image file, so that all the frames in the image file cannot be printed. Therefore, in step S708, the frames to be printed are automatically selected from all the frames.

When the frame to be printed is determined in step S708, in step S709, the selected frames are laid out on the paper according to the designation of the print layout, and printed.

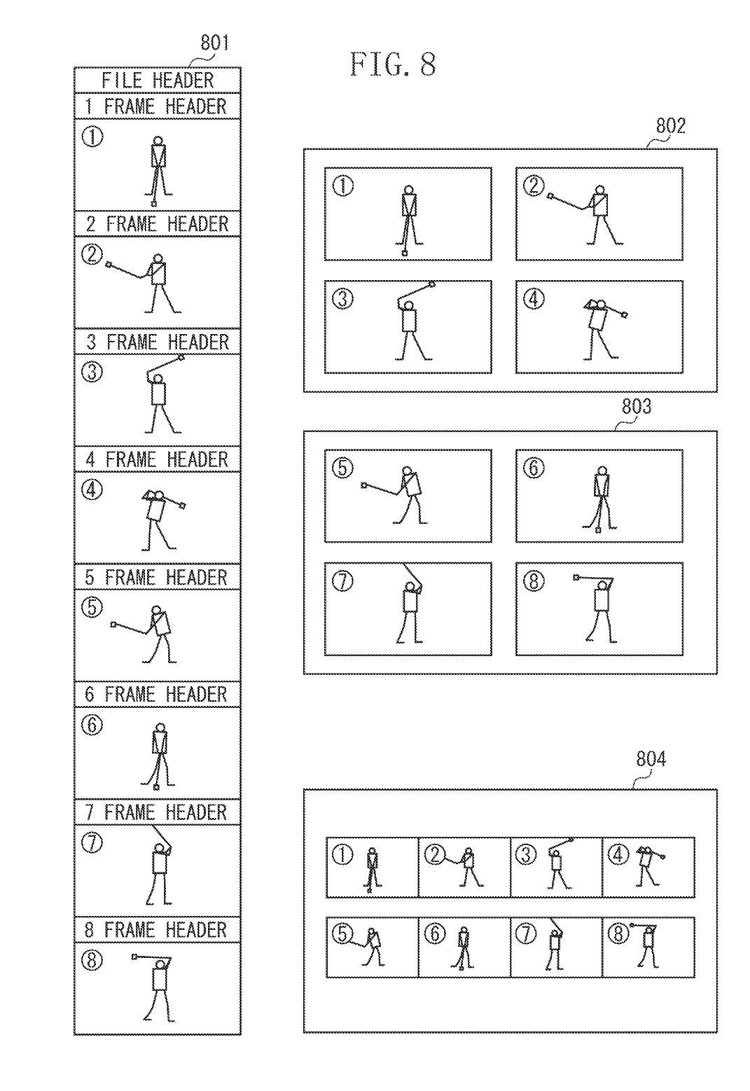

FIG. 8 illustrates an example in a case where all the frames of the image file can be printed according to the designation of the print layout in step S710.

The example is described above in which the NVMEM 118 is referred to in a case where the CPU 101 determines that the file format is the image file format consisting of a plurality of images in step S702 and the print layout designation 502 is performed in step S703, but it is not limited to this.

It is more effective to conduct the processing in step S704 and the subsequent steps in a case where the CPU 101 determines that the file format is the image file format consisting of a plurality of images in step S702 and the image type 302 in the file header 201 is “01” (indicating a continuously captured image). This is because in general a great number of continuously captured images are very similar to one another, so that it is very difficult to select a desired image from among such a great number of images.

FIG. 8 illustrates an example in a case where all the frames of the image file can be printed according to the designated print layout in step S710. Such printing is executed and controlled by the CPU 101 according to the program stored in the NVMEM 118 or the flash ROM 102.

In FIG. 8, there is illustrated a diagram 801 of each page data (each image frame) stored in the image file. This case shows that the page data has eight continuous page data (image frame) and the total number of frames is X=8. If the number of print layout frames “N=4” and the total number of print pages “M=2”, printing is performed as illustrated in diagrams 802 and 803 in FIG. 8. The diagram 802 illustrates a printing result on the first page and the diagram 803 illustrates a printing result on the second page.

If the number of print layout frames “N=8” and the total number of print pages “M=1”, printing is performed as illustrated in a diagram 804 in FIG. 8.

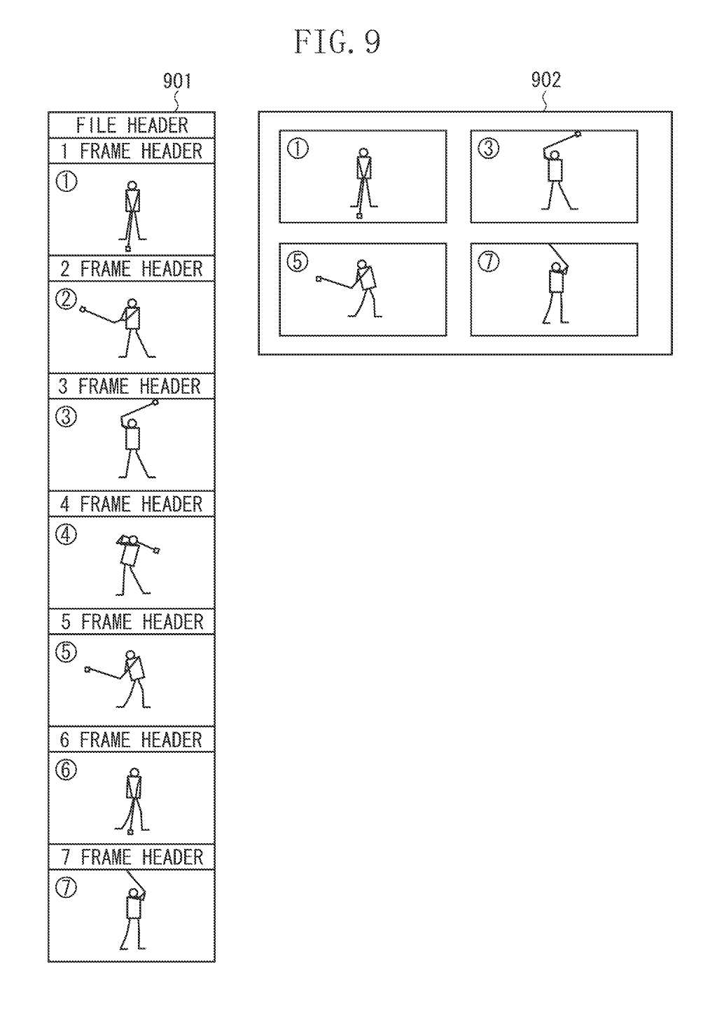

Referring to FIGS. 9, 10, and 11, a method for selecting a frame to be printed and a layout to be printed in step S708 is described. Such printing is executed and controlled by the CPU 101 according to the program stored in the NVMEM 118 or the flash ROM 102.

A diagram 902 in FIG. 9 illustrates an example in a case where a frame in which images in the image file indicated by a diagram 901 are selected by “equal thinning” in step S708, is printed.

If the total number of frames is seven, the designated number of print layout frames is four, and the total number of print pages is one, for example, the number of image frames in the file to be printed is 4×1=four frames. The CPU 101 selects the page data to be printed from the image file (the selection of the frame) according to the program stored in the NVMEM 118 or the flash ROM 102.

Four frames to be printed among the total number of frames of “seven frames” are equally extracted from the images in the file with the four frames kept continuous. As a result, the frames 1, 3, 5, and 7 are selected. At this point, printing is performed as indicated by a diagram 902.

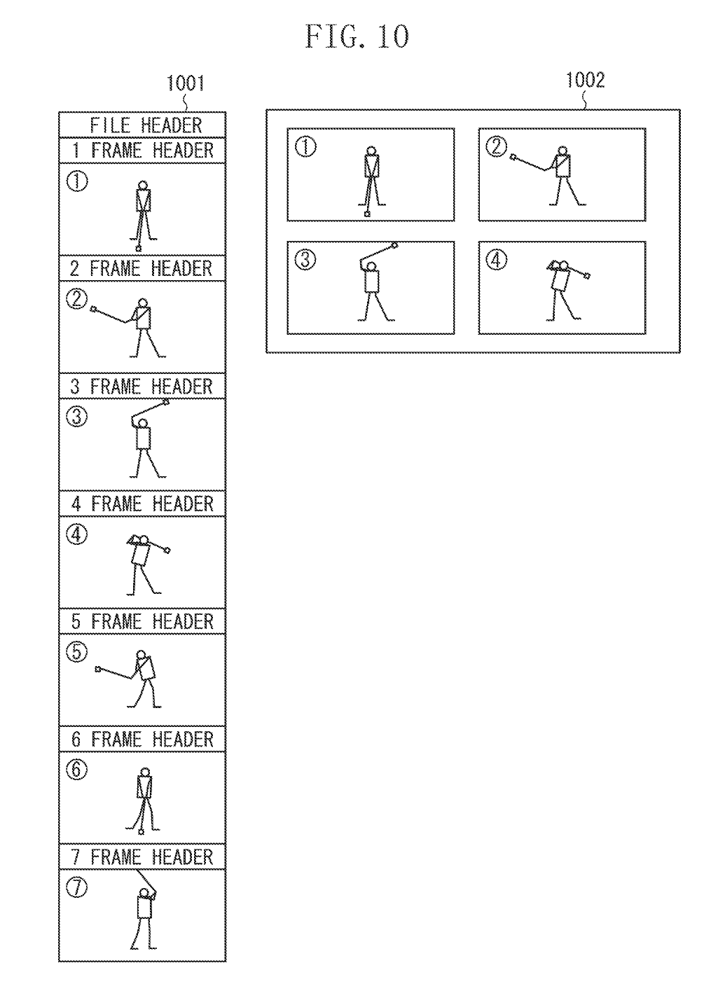

A diagram 1002 in FIG. 10 illustrates an example in a case where a frame in which images in the image file indicated by a diagram 1001 are selected by “sequence printing” in step S708 is printed.

If the total number of frames is seven, the designated number of print layout frames is four, and the total number of print pages is one, for example, the number of frames to be printed is 4×1=four frames as is the case with FIG. 9.

Four frames to be printed among the total number of frames of “seven frames” are continuously and sequentially extracted from the images in the file with the four frames kept continuous. As a result, the frames 1, 2, 3, and 4 are selected in that order from the first frame. At this point, printing is performed as indicated by the diagram 1002.

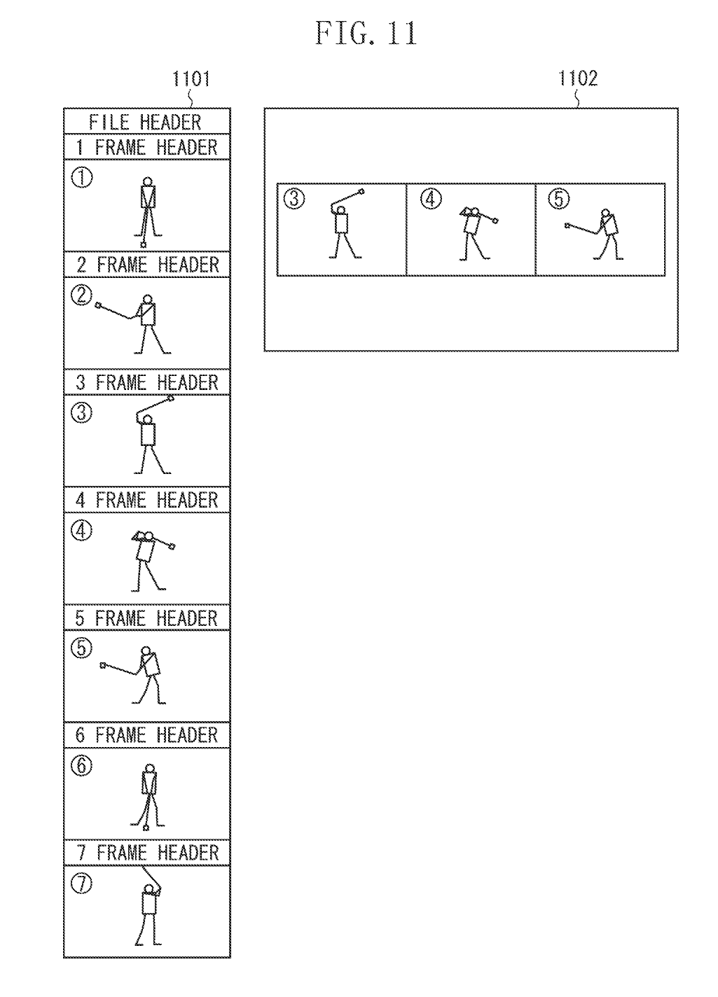

A diagram 1102 in FIG. 11 illustrates an example in a case where a frame in which images in the image file indicated by a diagram 1001 are selected by “central reference-point printing” in step S608 is printed.

If the total number of frames is seven, the designated number of print layout frames is three, and the total number of print pages is one, for example, the number of image frames in the file to be printed is 3×1=three frames.

Three frames to be printed, which are the frames 3, 4, and 5 including the frames before and after the frame 4 being the central frame in the file, are sequentially extracted from the total number of frames of “seven frames” with the three frames kept continuous. At this point, printing is performed as indicated by the diagram 1102.

The example is described above in which printing is performed with the center of a continuous image in the file as a reference-point, but it not limited to this. For example, the user designates any one of images in the file and may continuously extract three frames from the images before or after the designated image.

As described above, in the first exemplary embodiment of the present invention, if an image file format with a plurality of image frames is printed, a frame is automatically selected and printed instead of the user selecting all the frames to be printed.

More specifically, designating a method for selecting frames to be printed, the number of frames per page in designating the print layout, and the number of papers used for printing allows the image processing apparatus to automatically select frames.

In particular, if data format is of continuous image, layout printing can be performed with continuity being maintained without losing user's convenience.

In the first exemplary embodiment of the present invention, a method is described in which printing can be automatically performed with a suitable printing layout instead of the user selecting the frames to be printed in printing an image file format with a plurality of image frames.

In a second exemplary embodiment, a print control method is described in which the total number of pages to be printed and the number of frames desired to be printed among the frames in the image file with a plurality of image frames are designated to automatically calculate the number of frames to be printed per page and perform layout printing.

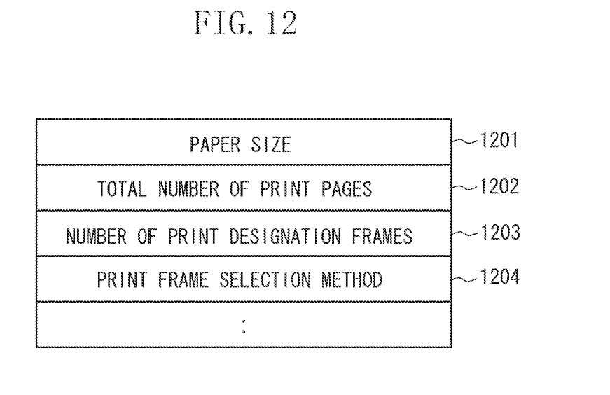

FIG. 12 illustrates an example print setting in outputting the image file illustrated in FIGS. 2 and 3.

Setting may be performed by the user using the operation unit I/F 104 or from other devices using the LAN I/F 119. The setting is stored in the NVMEM 118.

A paper size 1201 is the one for designating the paper size to be used in printing an image file. The total number of print pages 1202 is the one for designating the number of paper sheets to be used for printing one file.

The number of print designation frames 1203 is the one for designating the number of frames desired to be printed among a plurality of frames of the image file. A print frame selection method 1204 is the one for designating a method for selecting an image frame from the frames included in the image file.

In addition to the above print setting, information required for printing the image file, such as information about color/monochrome designation and resolution designation, is included. The description thereof is omitted herein.

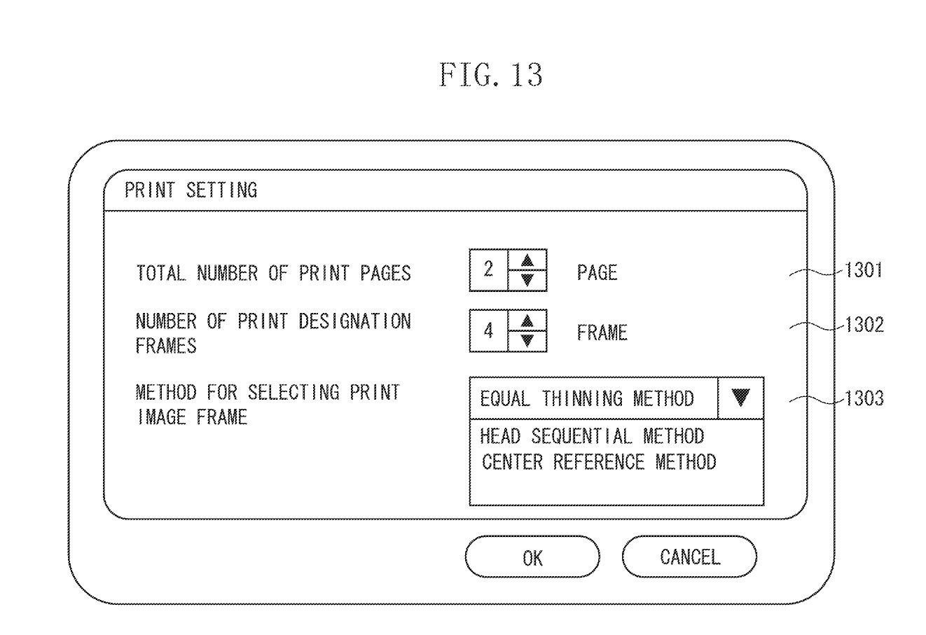

FIG. 13 illustrates an example display in a case where the print setting illustrated in FIG. 12 is designated by the operation unit 105. Such screen display is controlled by the CPU 101 according to the program stored in the NVMEM 118 or the flash ROM 102.

The operation unit 105 receives an instruction for display from the user and transmits the instruction to the CPU 101 via the operation unit I/F 104. The CPU 101 receives the instruction, reads a print setting screen stored in the NVMEM 118, and displays the print setting screen on the operation unit 105 according to the contents.

The print setting screen displayed on the operation unit 105 is described below. The total number of print pages 1301 is capable of setting the number of papers to be used for printing. The number of print designation frames 1302 is capable of designating the number of frames desired to be printed among a plurality of frames of the image file.

A print image frame selection method 1303 is capable of designating a method for selecting the image frame to be printed from among the frames included in the image file.

When the operation unit 105 receives the selection of the OK button 604 from the user, the selection is held in the print layout designation 502 in the NVMEM 118 via the operation unit I/F 104, and looked up when the CPU 101 generates printing data.

In the above, description is made so that setting is performed on the operation unit 105, but it is not limited to this. It is needless to say that the instruction may be received from other devices via the LAN I/F 119.

The example is described above in which the print image frame selection method 1303 is displayed in advance on the operation unit 105 before the printing is executed and designated. However, the print image frame selection method 1303 may be displayed on the operation unit 105 after the printing is executed so that a print image frame can be selected. The print setting screen illustrated in FIG. 13 is only an example and not limited to this.

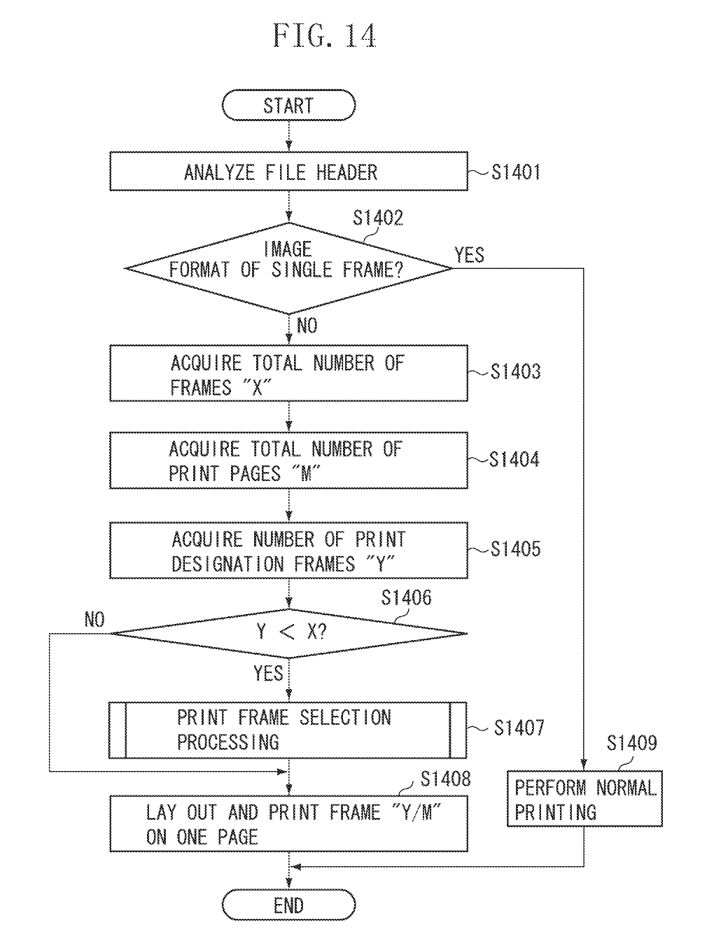

A specific method for using the setting items is described referring to FIG. 14.

FIG. 14 is a flow chart illustrating a flow for the image processing apparatus in a case where the image file is printed. The flow chart illustrated in FIG. 14 is executed by the CPU 101 according to the program stored in the NVMEM 118 or the flash ROM 102.

In step S1401, when the user input a file output operation on the operation unit I/F 104, the CPU 101 analyzes the image file header 201. In step S1402, the CPU 101 determines whether the file format is a normal image file format consisting of a single image formed of one image frame or an image file format comprised of a plurality of images based on the contents of the image type 301 in the file header 201.

If the CPU 101 determines that the file format is the image file format consisting of a plurality of images (NO in step S1402), in step S1403, the CPU 101 acquires the total number of frames 303 from the image file header 201, and temporarily stores the acquired total number of frames “X” in the RAM 103.

In step S1404, the CPU 101 refers to the NVMEM 118 to acquire the total number of print pages 1202 indicating the number of paper sheets to be used for printing, and temporarily stores the acquired total number of print pages “M” in the RAM 103.

In step S1405, the CPU 101 refers to the NVMEM 118 to acquire the number of print designation frames 1203 indicating the number of frames desired to be printed among a plurality of frames of the image file, and temporarily stores the acquired number of print designation frames “Y” in the RAM 103.

The CPU 101 refers to the total number of frames “X” and the number of print designation frames “Y” stored in the RAM 103 respectively in steps S1403 and S1405. In step S1406, the CPU 101 compares the number of print designation frames “Y” with the total number of frames “X” included in the image file, based on the referred numeric values.

If Y<X (YES in step 1406), the total number of frames “X” in the image file is greater than the number of frames desired to be printed “Y”, so that not all the frames in the image file can be printed. Therefore, in step S1407, frames to be printed are automatically selected from all the frames.

The CPU 101 calculates the number of layout printable frames per page based on the total number of print pages “M” and the number of print designation frames “Y” stored in the RAM 103 in steps S1404 and S1405. The number of layout printable frames per page is calculated by Y/M. In step S1408, Y/M frames are laid out on one page to be printed, and printed thereon.

If Y≧X (NO in step 1406), the total number of frames “X” in the image file is equal to or smaller than the number of frames desired to be printed “Y”, all the images in the image file can be printed. Therefore, step S1407 is not performed, but step S1408 is performed.

As described above, in the second exemplary embodiment, the number of frames to be printed per page can be automatically calculated to perform layout printing.

More specifically, the designation of the print frame selection method, the total number of print pages, and the number of frames among the frames in the image file with a plurality of image frames allows printing of an image file format with a plurality of image frames.

In the above, the example is described in which the NVMEM 118 is referred to if the CPU 101 determines that the file format is an image file format consisting of a plurality of images in step S1402, but not limited to this.

It is more effective to perform the processing in step S1403 and the subsequent steps in a case where the CPU 101 determines that the file format is the image file format consisting of a plurality of images in step S1402 and the image type 302 in the file header 201 is “01” (indicating a continuously captured image). This is because in general a great number of continuously captured images are very similar to one another, so that it is very difficult to select a desired image from among such a great number of images.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-169603 filed Jul. 28, 2010, which is hereby incorporated by reference herein in its entirety.

What is claimed is:

1. An image processing apparatus capable of printing a first image file including a plurality of image frames on a paper sheet, the image processing apparatus comprising:
a first obtaining unit configured to obtain a total number of the image frames included in the first image file;
a second obtaining unit configured to obtain a number of the image frames to be printed on one paper sheet;
a third obtaining unit configured to obtain a number of paper sheets to be used for printing; and
a selecting unit configured to automatically select the image frames to be printed based on the total number of the image frames obtained by the first obtaining unit, the number of the image frames to be printed on one paper obtained by the second obtaining unit, and the number of paper sheets to be used for printing obtained by the third obtaining unit.

2. An image processing apparatus capable of printing one first image file including a plurality of image frames on a paper sheet, the image processing apparatus comprising:
a first obtaining unit configured to obtain a total number of the image frames included in the first image file;
a fourth obtaining unit configured to obtain a number of frames to be printed; and
a selecting unit configured to automatically select the image frames to be printed based on the total number of the image frames obtained by the first obtaining unit and the number of frames to be printed obtained by the fourth obtaining unit.

3. The image processing apparatus according to claim 1, wherein the selecting unit executes selection in a case where the image file including the image to be printed on the paper sheet is the first image file including the plurality of image frames.

4. The image processing apparatus according to claim 1, wherein the selecting unit does not execute selection in a case where the image file including an image to be printed on the paper sheet is the second image file including only a single image frame.

5. The image processing apparatus according to claim 1, further comprising a determining unit configured to determine whether the image file including an image to be printed on the paper sheet is the first image file including the plurality of image frames or the second image file including only a single image frame.

6. The image processing apparatus according to claim 1, further comprising a printing unit configured to print the image frames selected by the selecting unit on a paper sheet.

7. The image processing apparatus according to claim 1, wherein the image frames included in the first image file are continuously stored, and
wherein the selecting unit includes at least any one of a first extracting unit configured to equally extract an image frame from the image frames included in the first image file and continuously stored, and a second extracting unit configured to sequentially extract the predetermined number of image frames from a specific position of the image frame included in the first image file and continuously stored.

8. The image processing apparatus according to claim 1, wherein the selecting unit executes selection based on the number of the image frames obtained by the first obtaining unit, the number of the image frames to be printed on one paper sheet obtained by the second obtaining unit, and the number of paper sheets to be used for printing obtained by the third obtaining unit in a case where not all the image frames obtained by the first obtaining unit can be printed.

9. The image processing apparatus according to claim 2, wherein the selecting unit automatically selects the image frames to be printed in a case where the number of the image frames to be printed obtained by the fourth obtaining unit is smaller than the number of the image frames obtained by the first obtaining unit.

10. The image processing apparatus according to claim 2, further comprising a third obtaining unit configured to obtain the number of paper sheets to be used for printing,
wherein the number of the image frames to be printed on one paper sheet is determined based on the number of paper sheets to be used for printing obtained by the third obtaining unit and the number of the image frames to be printed obtained by the fourth obtaining unit.

11. A control method for controlling an image processing apparatus for printing a first image file including a plurality of image frames on a paper sheet, the control method comprising:
a first obtaining step of obtaining a total number of the image frames included in the first image file;
a second obtaining step of obtaining a number of image frames to be printed on one paper sheet;
a third obtaining step of obtaining a number of paper sheets to be used for printing; and
a selecting step of automatically selecting the image frames to be printed based on the total number of the image frames obtained by the first obtaining step, the number of the image frames to be printed on one paper sheet obtained by the second obtaining step, and the number of paper sheets to be used for printing obtained by the third obtaining step.
